(19) United States
(12) Patent Application Publication
(10) Pub. No.: US 2014/0217845 A1
(43) Pub. Date: Aug. 7, 2014

(54) DEVICE TO PREVENT FOREIGN OBJECTS FROM ENTERING SCREW HOLES OF BRUSHLESS MOTOR OF CEILING FAN

(71) Applicant: RHINE ELECTRONIC CO., LTD., Taichung (TW)

(72) Inventor: YI KAI CHANG, TAICHANG (TW)

(73) Assignee: RHINE ELECTRONIC CO., LTD., Taichung (TW)

(21) Appl. No.: 13/775,619

(22) Filed: Feb. 25, 2013

(30) Foreign Application Priority Data
Feb. 7, 2013 (TW) 102202767

(51) Int. Cl. H02K 5/10

(52) U.S. Cl. CPC H02K 5/10
USPC 310/89

(57) ABSTRACT

The present invention relates to a device to prevent foreign objects from entering screw holes of a brushless motor of a ceiling fan. The device includes a cover to prevent foreign objects and a motor cover. The cover is adapted to cover screw holes of the motor cover. The cover has a hollow cover body which has an accommodation space corresponding in position to the screw holes of the motor cover. The ends of screws are in the accommodation space of the hollow cover body of the cover so that the iron fillings of the screws and foreign objects will fall in the accommodation space. The present invention can prevent the iron fillings of the screws and foreign objects from entering the motor to cause noises so as to enhance the reliability of the product and prolong the service life the product.

### BACKGROUND OF THE INVENTION

1. Field of the Invention

The present invention relates to a device applied to a motor structure, and more particularly, to a device to prevent foreign objects from entering screw holes of a brushless motor of a ceiling fan.

2. Description of the Prior Art

As shown in FIG. 12, a conventional motor cover 20 has a plurality screw holes 23 so that screws are screwed to the screw holes 23 for connection of an auxiliary structure. However, it has the following shortcomings:

1. The product is not reliable. When the screws are screwed to the screw holes of the motor cover, the iron fillings of the screws will fall into the motor. The iron fillings will be attracted by the magnetic force of the stator and the rotor of the motor to cause noises and to increase friction when the motor runs so the product is not reliable.

2. The service life of the product is short. When the screws are screwed to the screw holes of the motor cover, the iron fillings of the screws will fall into the motor to cause friction when the motor runs. Besides, foreign objects may fall into the motor with ease when packing the motor. It is not easy to clean the foreign objects, which will influence running of the motor so the service life of the product is short.

Accordingly, the inventor of the present invention has devoted himself based on his many years of practical experiences to solve these problems.

### SUMMARY OF THE INVENTION

The primary object of the present invention is to provide a device to prevent foreign objects from entering screw holes of a brushless motor of a ceiling fan. The device comprises a cover to prevent foreign objects and a motor cover. The cover has a hollow cover body. The hollow cover body has a closed end, an open end and an accommodation space formed between the closed end and the open end. The motor cover has a top face, a bottom face and a plurality of screw holes between the top face and the bottom face. The cover has a plurality of spaced stoppers in the accommodation space of the hollow cover body. The cover is in the form of three, four or five fan-shaped blades relative to the top face of the motor cover. Through the cover to cover the bottom face of the motor cover, the screw holes of the motor cover correspond in position to the accommodation space of the hollow cover body of the cover and the open end of the hollow cover body is attached to the bottom face of the motor cover. Two sides of the open end of the hollow cover body have a plurality of lock holes, and the motor cover has corresponding positioning threaded holes for connection of screws. When the cover and the motor cover are assembled, the screws are screwed to the positioning threaded holes of the motor cover and the lock holes of the cover. Alternatively, two sides of the open end of the hollow cover body have a plurality of protruding hooks, and the motor cover has corresponding engaging holes. When the cover and the motor cover are assembled, the protruding hooks of the cover engage with the engaging holes of the motor cover. The ends of the screws are in the accommodation space of the hollow cover body of the cover so that the iron fillings of the screws and foreign objects will fall in the accommodation space. The present invention can prevent the iron fillings of the screws and foreign objects from entering the motor to cause noises. The spaced stoppers and the cover in the form of three, four or five fan-shaped blades are to increase variation of use. The positioning threaded holes to cooperate with the lock holes as well as the protruding hooks to cooperate with the engaging holes are to enhance assembly convenience. The present invention can enhance the reliability of the product and prolong the service life the product.

### BRIEF DESCRIPTION OF THE DRAWINGS

FIG. 1 is a partial exploded view showing the cover and the motor cover of the present invention to cooperate the motor ring;

FIG. 2 is an exploded view of the present invention;

FIG. 3 is a sectional and partial enlarged view of the present invention;

FIG. 4 is a sectional and partial enlarged view of the present invention in an operating state;

FIG. 5 is an exploded view showing the cover and the motor cover of the present invention to cooperate the motor ring;

FIG. 6 is an exploded view showing a plurality of spaced stoppers disposed in the accommodation space according to a first embodiment of the present invention;

FIG. 7 is an exploded view showing the cover in the form of three fan-shaped blades according to a second embodiment of the present invention;

FIG. 8 is an exploded view showing the cover in the form of four fan-shaped blades according to a third embodiment of the present invention;

FIG. 9 is an exploded view showing the cover in the form of five fan-shaped blades according to a fourth embodiment of the present invention;

FIG. 10 is an exploded view showing the lock holes at the open end of the cover and the positioning threaded holes of the motor cover according to a fifth embodiment of the present invention;

FIG. 11 is an exploded view showing the protruding hooks at the open end of the cover and the engaging holes of the motor cover according to a sixth embodiment of the present invention;

FIG. 12 is a schematic view of the prior art.

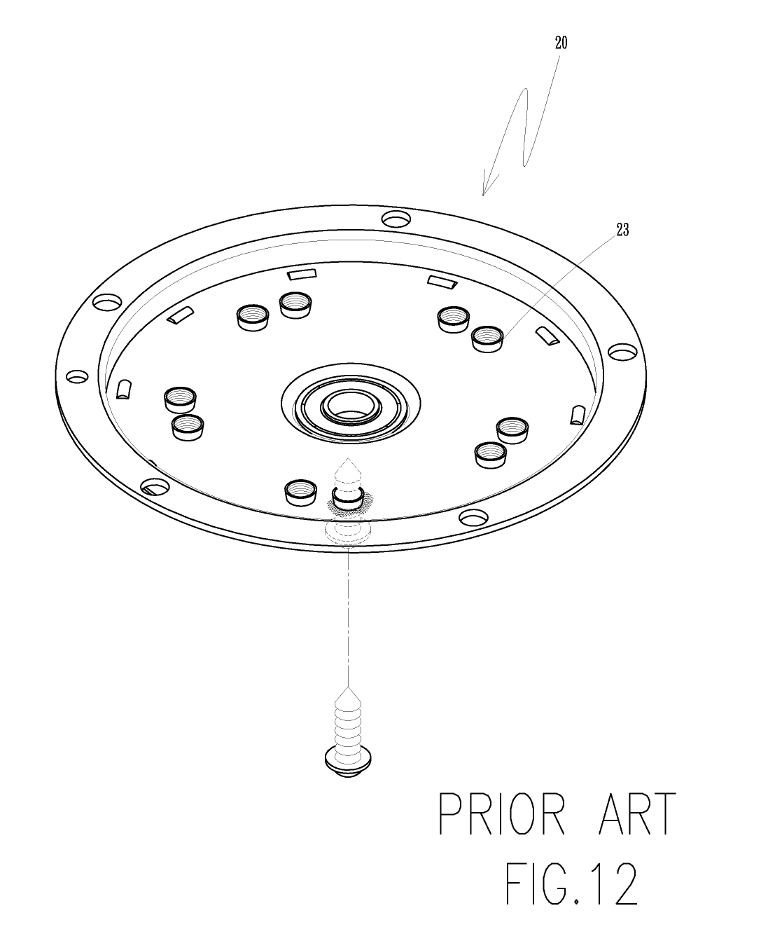

### DETAILED DESCRIPTION OF THE PREFERRED EMBODIMENTS

Embodiments of the present invention will now be described, by way of example only, with reference to the accompanying drawings.

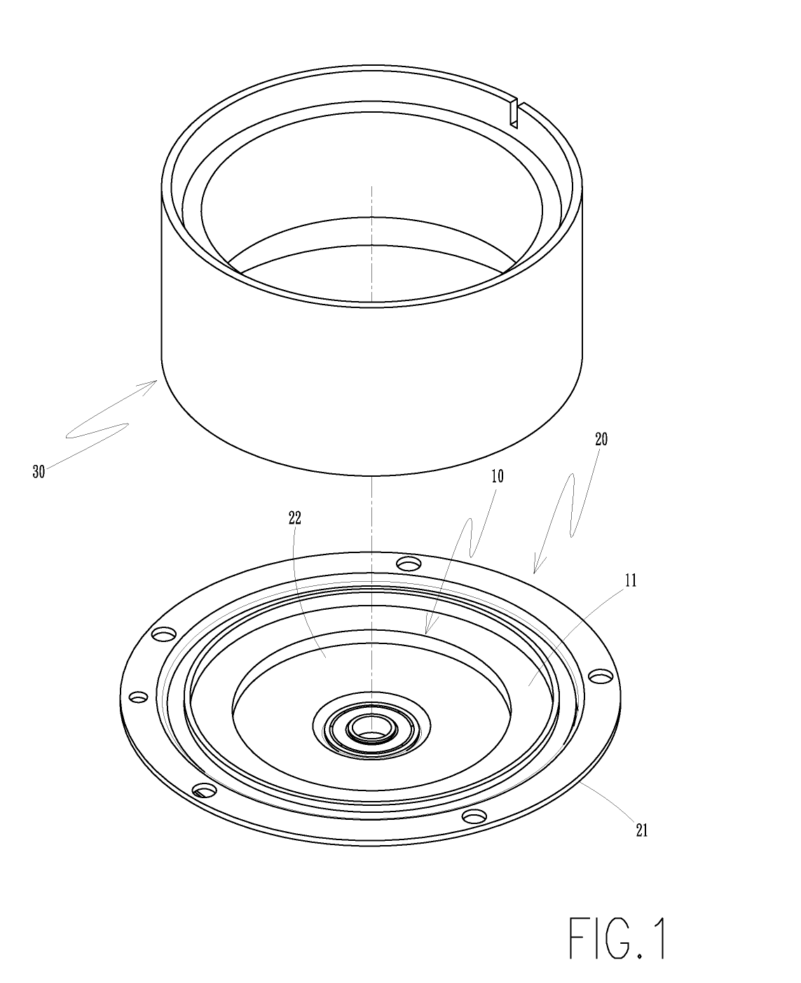

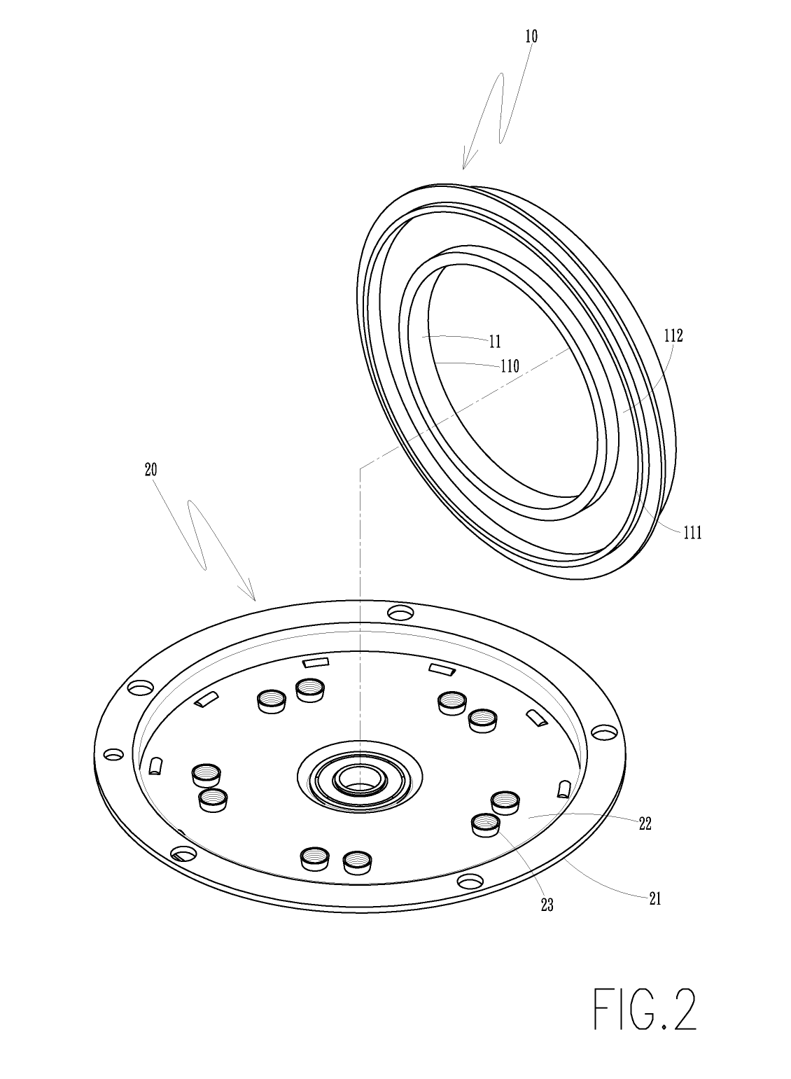

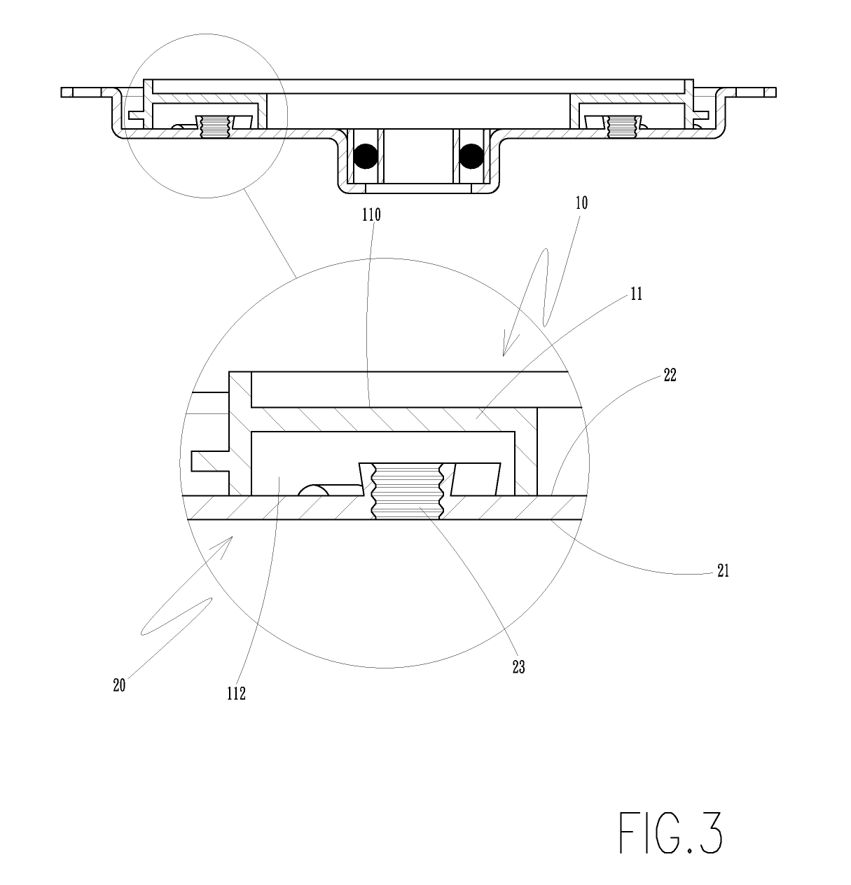

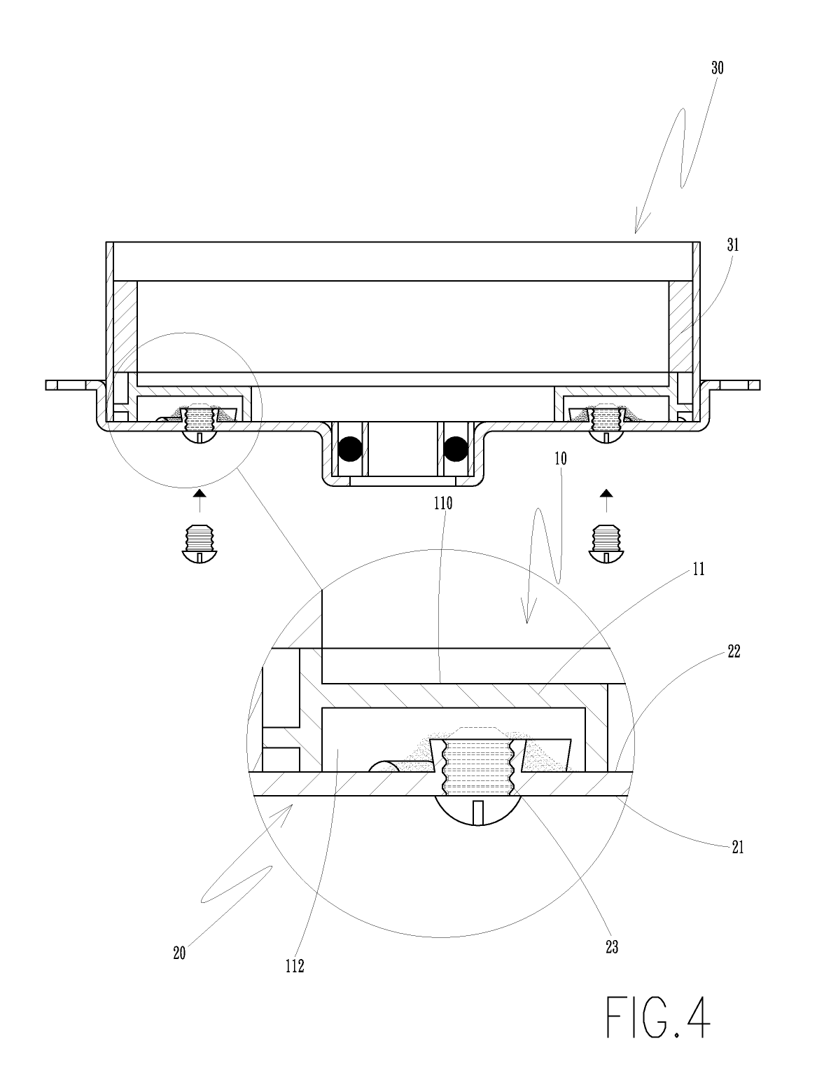

FIG. 1 is a partial exploded view showing a cover and a motor cover of the present invention to cooperate a motor ring. FIG. 2 is an exploded view of the present invention. FIG. 3 is a sectional and partial enlarged view of the present invention. FIG. 4 is a sectional and partial enlarged view of the present invention in an operating state. The present invention comprises a cover 10 to prevent foreign objects, a motor cover 20, and a motor ring 30.

The cover 10 has a hollow cover body 11. The hollow cover body 11 has a closed end 110, an open end 111, and an accommodation space 112 formed between the closed end 110 and the open end 111.

The motor cover 20 has a top face 21, a bottom face 22, and a plurality of screw holes 23 between the top face 21 and the bottom face 22. The cover 10 is adapted to cover the bottom face 22 of the motor cover 20, and the screw holes 23 correspond in position to the accommodation space 112 of the hollow cover body 11 of the cover 10.

The motor ring 30 has a magnetic ring 31 therein. One end of the motor ring 30 is mounted to the bottom face 22 of the motor cover 20.

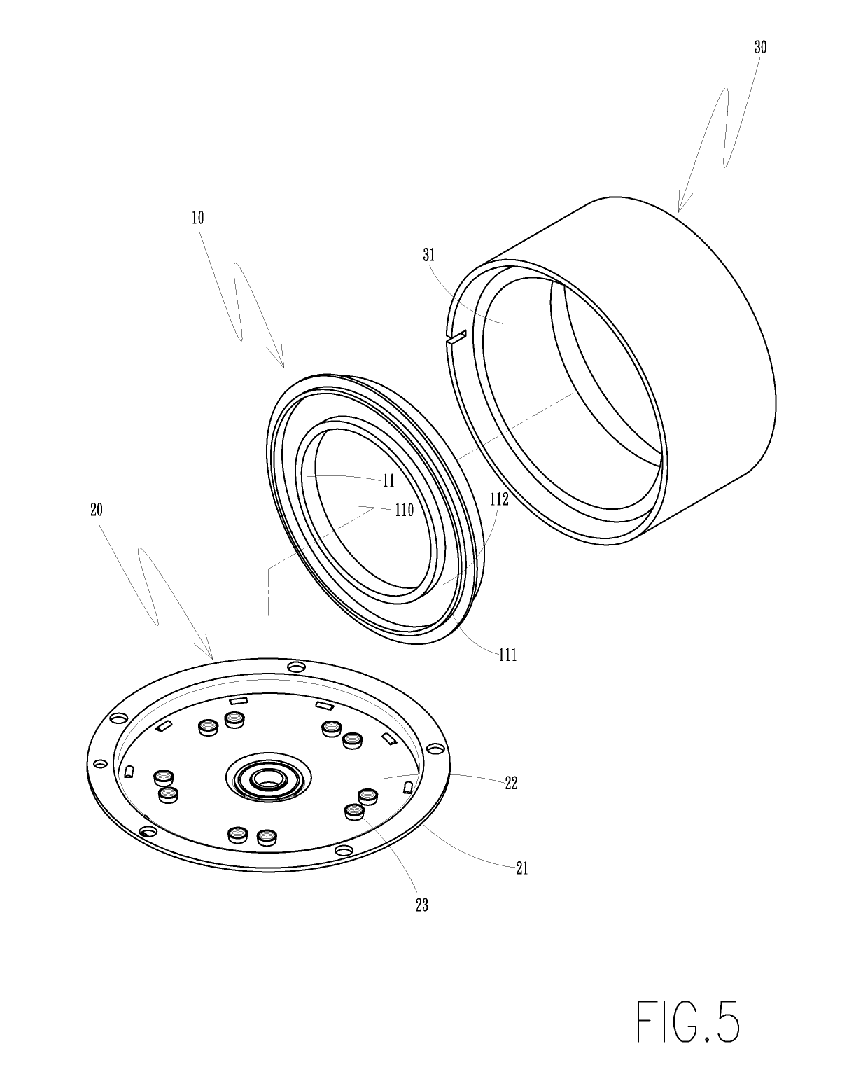

As shown in FIG. 2 to FIG. 5, the cover 10 is to cover the bottom face 22 of the motor cover 20, and the accommodation space 112 of the hollow cover body 11 corresponds in position to the screw holes 23 of the motor cover 20. The open end 111 of the hollow cover body 11 is attached to the bottom face 22 of the motor cover 20. When screws are locked to the screw holes 23, the ends of the screws are in the accommodation space 112 of the hollow cover body 11 of the cover 10 so that the iron fillings of the screws and foreign objects will fall in the accommodation space 112. The present invention can prevent the iron fillings of the screws and foreign objects from entering the motor to cause noises and enhance the reliability of the product and prolong the service life the product.

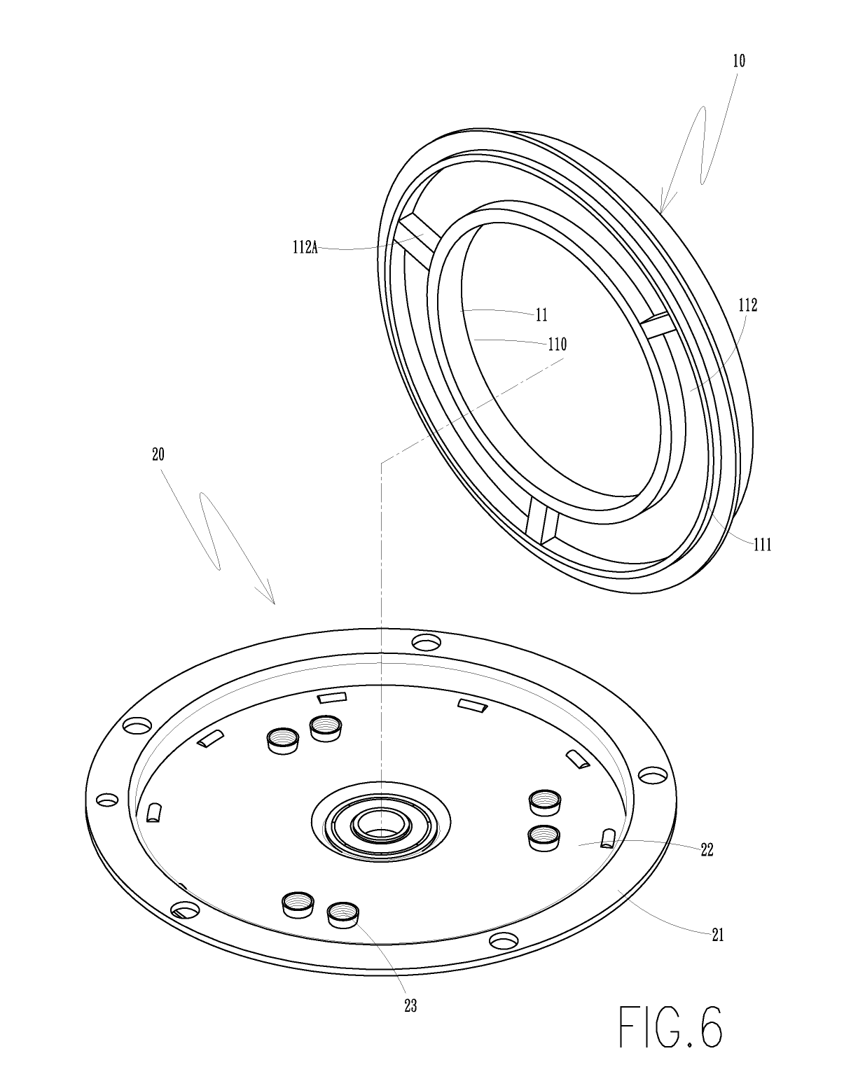

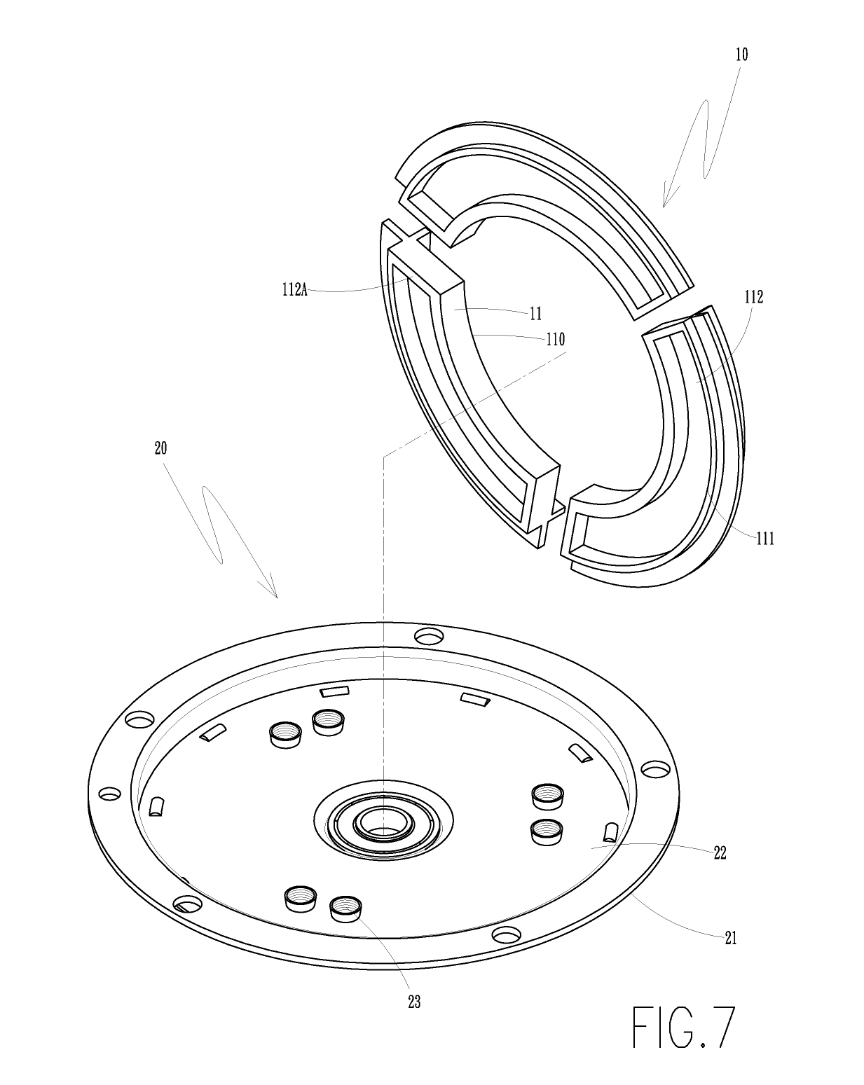

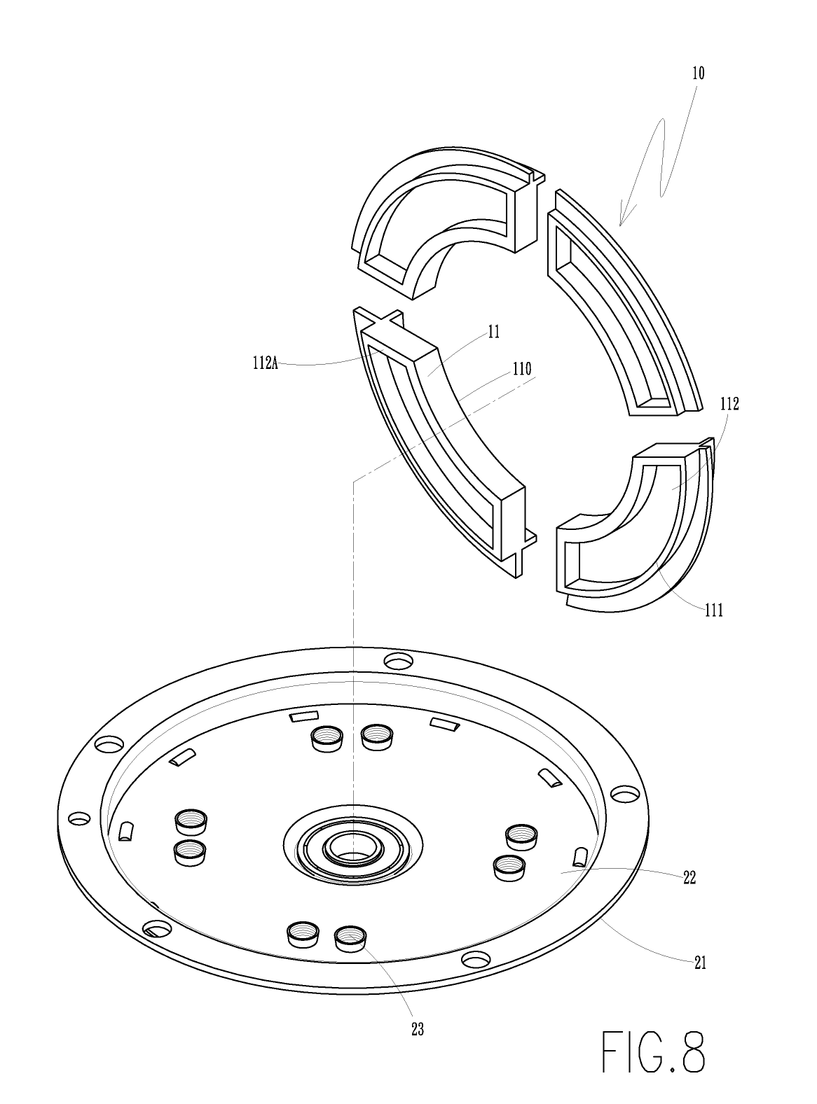

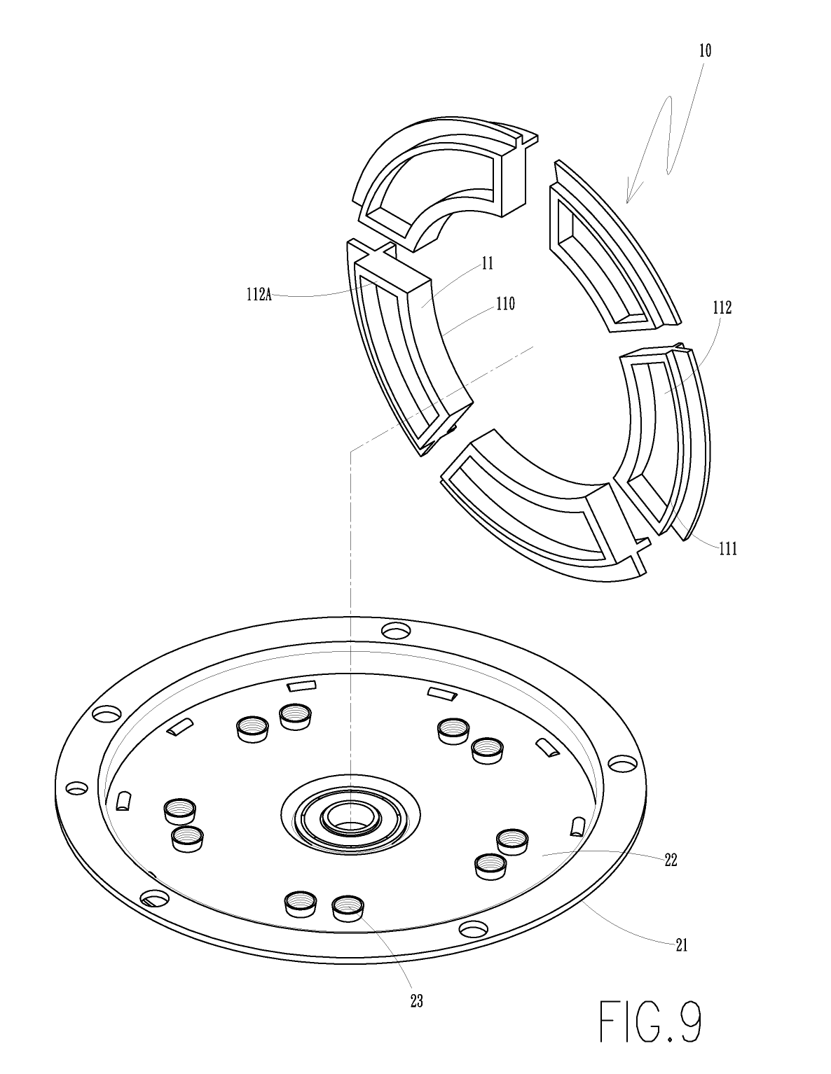

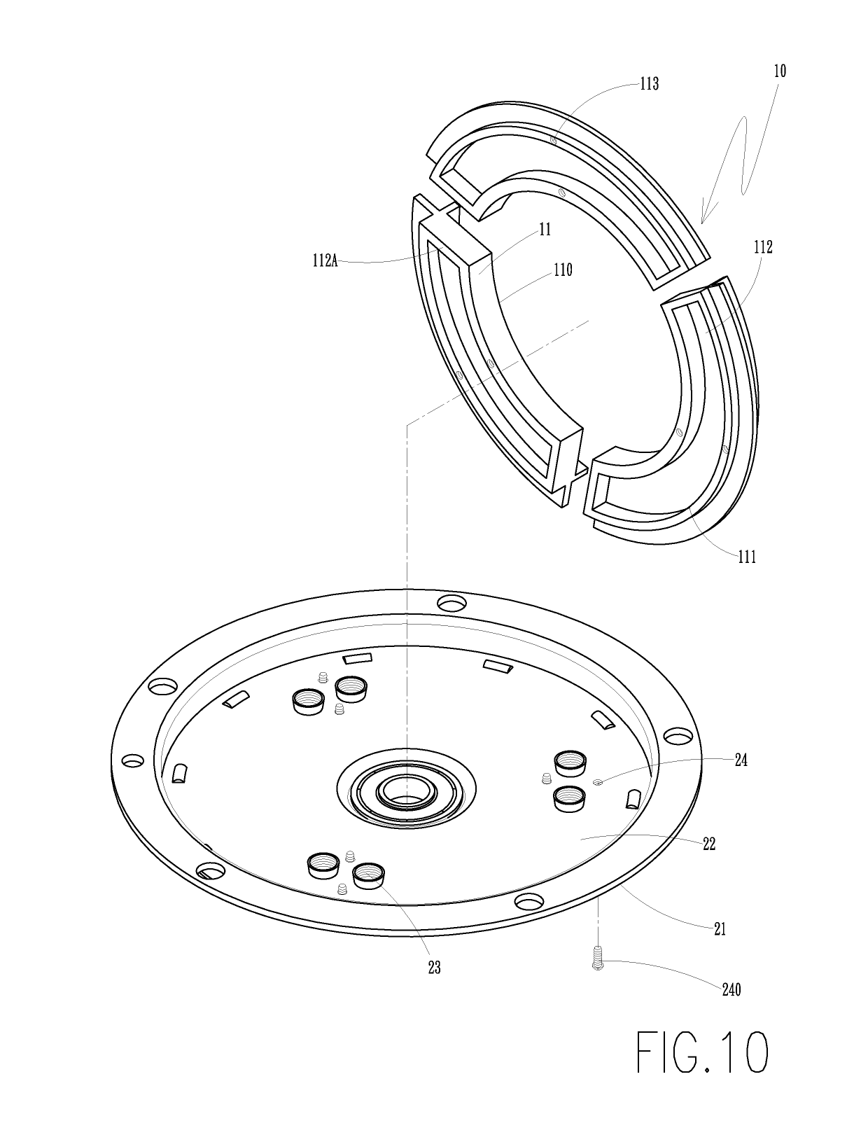

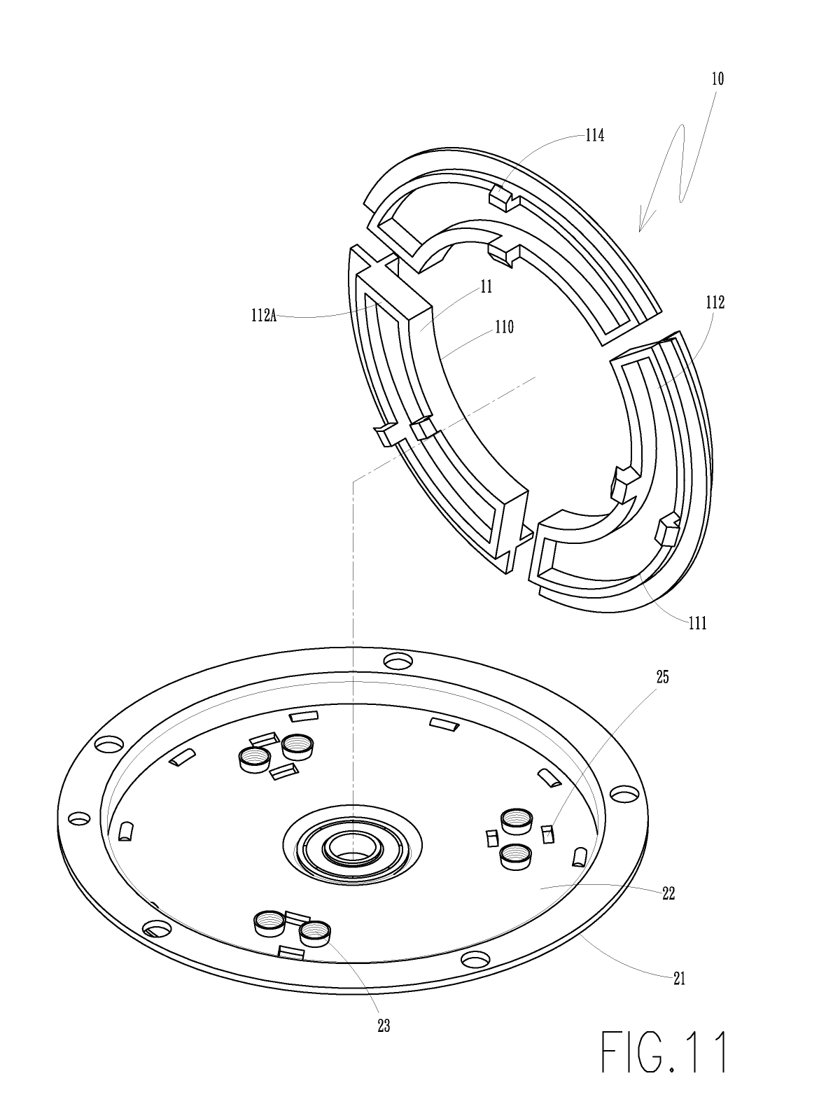

FIG. 6 is an exploded view showing a plurality of spaced stoppers disposed in the accommodation space according to a first embodiment of the present invention. FIG. 7 is an exploded view showing the cover in the form of three fan-shaped blades according to a second embodiment of the present invention. FIG. 8 is an exploded view showing the cover in the form of four fan-shaped blades according to a third embodiment of the present invention. FIG. 9 is an exploded view showing the cover in the form of five fan-shaped blades according to a fourth embodiment of the present invention. FIG. 10 is an exploded view showing the lock holes at the open end of the cover and the positioning threaded holes of the motor cover according to a fifth embodiment of the present invention. FIG. 11 is an exploded view showing the protruding hooks at the open end of the cover and the engaging holes of the motor cover according to a sixth embodiment of the present invention. These embodiments are substantially similar to FIG. 1 to FIG. 3 with the exceptions described hereinafter. As shown in FIG. 6, the cover 10 has a plurality of spaced stoppers 112A in the accommodation space 112. As shown in FIG. 7, the cover 10 is in the form of three fan-shaped blades relative to the top face 21 of the motor cover 20. As shown in FIG. 8, the cover 10 is in the form of four fan-shaped blades relative to the top face 21 of the motor cover 20. As shown in FIG. 9, the cover 10 is in the form of five fan-shaped blades relative to the top face 21 of the motor cover 20. As shown in FIG. 10, two sides of the open end 111 of the hollow cover body 11 have a plurality of lock holes 113, and the motor cover 20 has corresponding positioning threaded holes 24 for connection of screws 240. When the cover 10 and the motor cover 20 are assembled, the screws 240 are screwed to the positioning threaded holes 24 of the motor cover 20 and the lock holes 113 of the cover 10. As shown in FIG. 11, two sides of the open end 111 of the hollow cover body 11 have a plurality of protruding hooks 114, and the motor cover 20 has corresponding engaging holes 25. When the cover 10 and the motor cover 20 are assembled, the protruding hooks 114 of the cover 10 engage with the engaging holes 25 of the motor cover 20, preventing iron fillings and foreign objects from entering the motor to cause noises and to lower the stability of the motor. The spaced stoppers and the cover in the form of three, four or five fan-shaped blades are to increase variation of use. The positioning threaded holes to cooperate with the lock holes as well as the protruding hooks to cooperate with the engaging holes are to enhance assembly convenience. The present invention can be used in different ways.

The advantages of the present invention are as follows:

1. The reliability of the product can be enhanced. When the screws are locked to the screw holes of the motor cover, the ends of the screws are in the accommodation space of the hollow cover body of the cover so that iron fillings and foreign objects will fall in the accommodation space. The present invention can prevent iron fillings and foreign objects from entering the motor to cause noises and enhance the reliability of the product.

2. The service life of the product can be prolonged. When screws are locked to the screw holes, the ends of the screws are in the accommodation space of the hollow cover body of the cover so that iron fillings and foreign objects will fall in the accommodation space. The present invention can prevent iron fillings and foreign objects from entering the motor to cause noises and enhance the reliability of the product and prolong the service life of the product.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A device to prevent foreign objects from entering screw holes of a brushless motor of a ceiling fan, comprising:
a cover to prevent foreign objects, the cover having a hollow cover body, the hollow cover body having a closed end, an open end and an accommodation space formed between the closed end and the open end.

2. The device to prevent foreign objects from entering screw holes of a brushless motor of a ceiling fan as claimed in claim 1, wherein the cover has a plurality of spaced stoppers in the accommodation space of the hollow cover body.

3. The device to prevent foreign objects from entering screw holes of a brushless motor of a ceiling fan as claimed in claim 1, wherein the cover is in the form of three, four or five fan-shaped blades.

4. A device to prevent foreign objects from entering screw holes of a brushless motor of a ceiling fan, comprising:
a cover to prevent foreign objects, the cover having a hollow cover body, the hollow cover body having a closed end, an open end and an accommodation space formed between the closed end and the open end; and
a motor cover, the motor cover having a top face, a bottom face and a plurality of screw holes between the top face and the bottom face, the cover being adapted to cover the bottom face of the motor cover, the screw holes corresponding in position to the accommodation space of the hollow cover body of the cover.

5. The device to prevent foreign objects from entering screw holes of a brushless motor of a ceiling fan as claimed in claim 4, wherein the cover has a plurality of spaced stoppers in the accommodation space of the hollow cover body.

6. The device to prevent foreign objects from entering screw holes of a brushless motor of a ceiling fan as claimed in claim 4, wherein the cover is in the form of three, four or five fan-shaped blades.

7. The device to prevent foreign objects from entering screw holes of a brushless motor of a ceiling fan as claimed in claim 4, wherein two sides of the open end of the hollow cover body have a plurality of lock holes, the motor cover has corresponding positioning threaded holes for connection of screws, when the cover and the motor cover are assembled, the screws are screwed to the positioning threaded holes of the motor cover and the lock holes of the cover.

8. The device to prevent foreign objects from entering screw holes of a brushless motor of a ceiling fan as claimed in claim 4, wherein two sides of the open end of the hollow cover body have a plurality of protruding hooks, the motor cover has corresponding engaging holes, when the cover and the motor cover are assembled, the protruding hooks of the cover engage with the engaging holes of the motor cover.
